(19) United States
(12) Patent Application Publication
(10) Pub. No.: US 2015/0285369 A1
(43) Pub. Date: Oct. 8, 2015

(54) ACTIVE THERMAL HYDRAULIC FLUID LEVEL CONTROL FOR AN AUTOMATIC TRANSMISSION

(71) Applicant: GM Global Technology Operations LLC, Detroit, MI (US)

(72) Inventors: Christopher G. Benson, Rochester Hills, MI (US); Todd R. Berger, Pinckney, MI (US); Mark David Kieliszewski, Clarkston, MI (US); Philip C. Lundberg, Keego Harbor, MI (US)

(21) Appl. No.: 14/676,444

(22) Filed: Apr. 1, 2015

Related U.S. Application Data
(60) Provisional application No. 61/976,819, filed on Apr. 8, 2014.

(51) Int. Cl. F16H 57/04; F16K 31/00

(52) U.S. Cl. CPC F16H 57/0447; F16H 57/0409; F16H 57/045; F16K 31/002

(57) ABSTRACT

An active thermal hydraulic control system for a transmission is provided. The active thermal hydraulic control system improves fuel economy by storing transmission fluid in areas away from rotating components during hot operation. However, during other conditions the transmission fluid is kept in the sump. The active thermal hydraulic control system includes an active thermal valve. The active thermal valve is an electro-mechanical device which converts electrical energy into thermal energy which melts a wax pellet which in turn moves a plunger. Movement of the plunger controls the opening and closing of a valve that communicates between the sump and the side or front cover of the transmission. The system improves fuel economy by as much as 0.5% by storing excess hydraulic fluid away from rotating components.

### CROSS-REFERENCE TO RELATED APPLICATIONS

This application claims the benefit of U.S. Provisional Application No. 61/976,819 filed Apr. 8, 2014. The disclosure of the above application is incorporated herein by reference.

### TECHNICAL FIELD

The invention relates to an active thermal hydraulic fluid level control system for an automatic transmission, and more particularly to a control system for actively controlling hydraulic fluid level between a sump and a side or front cover in an automatic transmission.

### BACKGROUND

A typical automatic transmission includes a hydraulic control system that is employed to provide cooling and lubrication to components within the transmission and to actuate a plurality of torque transmitting devices such as clutches and brakes. The hydraulic control system typically includes a sump located at a bottom of the transmission that collects the hydraulic fluid from the remainder of the hydraulic control system. The sump stores the hydraulic fluid to be suctioned back into the hydraulic control system by a pump. A minimum level of hydraulic fluid is required in the sump in order to feed the hydraulic control system for all ranges of transmission operation and to account for dynamic movement of the hydraulic fluid within the sump. It is desirable to keep the amount of hydraulic stored in the sump to this minimum level since hydraulic fluid in the sump interferes with the rotating components of the transmission. The rotating components, including for example gears, clutch plates, and interconnecting members, traveling through the stored hydraulic fluid within the sump experience increased drag, thus increasing spin losses and in turn decreasing the efficiency of the transmission.

The minimum level of hydraulic fluid that must be stored in the sump varies based on various factors including the operating temperature of the hydraulic fluid. Therefore it is desirable to store excess hydraulic fluid out of the sump and in a separate area that does not interfere with rotating components. One solution is to actively control the level of hydraulic fluid between the sump and a front or side cover of the transmission using a passive thermal valve. These passive thermal valves allow hydraulic fluid to flow between the sump and the front cover based on the temperature of the hydraulic fluid. While these systems are useful for their intended purpose, there is a need in the art for an active control system that minimizes cost and mass and that allows excess hydraulic fluid to be stored out of the sump during normal operating conditions but not during certain other conditions, such as end-of-line testing or transportation of the transmission.

### SUMMARY

An active thermal hydraulic control system for a transmission is provided. The active thermal hydraulic control system improves fuel economy by storing transmission fluid in areas away from rotating components during hot operation. However, during other conditions the transmission fluid is kept in the sump. The active thermal hydraulic control system includes an active thermal valve. The active thermal valve is an electro-mechanical device which converts electrical energy into thermal energy which melts a wax pellet which in turn moves a plunger. Movement of the plunger controls the opening and closing of a valve that communicates between the sump and the side or front cover of the transmission. The system improves fuel economy by as much as 0.5% by storing excess hydraulic fluid away from rotating components.

In one aspect, an assembly for use in a transmission of a motor vehicle includes a first fluid reservoir, a second fluid reservoir, and a control valve assembly. The control valve assembly includes a heat source, a wax element configured to undergo a phase change in response to the heat source, a valve moveable between a first position and a second position by the phase change of the wax element, and a sleeve having a first port and a second port. The first port is in direct fluid communication with the first fluid reservoir and the second port is in direct fluid communication with the second fluid reservoir and the valve allows fluid communication between the first port and the second port when in the first position and prevents fluid communication between the first port and the second port when in the second position.

In another aspect, the first fluid reservoir is located in a sump of the transmission and the second fluid reservoir is located in a side cover of the transmission.

In yet another aspect, the wax element includes a pressure resistant vessel filled with a temperature tuned wax, wherein the wax undergoes the phase change at a specific temperature.

In yet another aspect, the wax element further includes a pin partially slidably disposed within the pressure resistant vessel and extending out into the sleeve to contact the valve.

In yet another aspect, a biasing member is disposed within the sleeve to bias the valve to the second position.

In yet another aspect, the heat source is a coil disposed around the wax element to which a current is applied to generate heat.

In yet another aspect, the wax element undergoes the phase change when an operating temperature of the transmission exceeds a threshold.

In yet another aspect, a separator wall is disposed between the first fluid reservoir and the second fluid reservoir, and the control valve assembly is connected to the separator wall and the sleeve is extended through the separator wall.

In yet another aspect, the separator wall includes a support collar that receives the sleeve of the control valve assembly.

In yet another aspect, the first port is disposed in a distal end of the sleeve and the second port is disposed in a side surface of the sleeve.

In yet another aspect, the valve covers the second port when the valve is in the second position.

Further features, aspects, and advantages will become apparent by reference to the following description and appended drawings wherein like reference numbers refer to the same component, element or feature.

### BRIEF DESCRIPTION OF THE DRAWINGS

The drawings described herein are for illustration purposes only and are not intended to limit the scope of the present disclosure in any way.

FIG. 1 is a schematic diagram of an exemplary front wheel drive transmission according to the principles of the present invention;

FIG. 2 is an enlarged cross section of a portion of the exemplary front wheel drive transmission shown in FIG. 1;

FIG. 3 is a front or side view of the exemplary front wheel drive transmission of FIG. 1 with a side or front cover removed;

FIG. 4 is a side view of a control valve assembly used in the exemplary front wheel drive transmission according to the principles of the present invention;

FIG. 5A is a cross-sectional view taken in the direction of arrows 5-5 in FIG. 4 of the control valve assembly in a first position; and

FIG. 5B is a cross-sectional view taken in the direction of arrows 5-5 in FIG. 4 of the control valve assembly in a second position.

### DESCRIPTION

The following description is merely exemplary in nature and is not intended to limit the present disclosure, application, or uses.

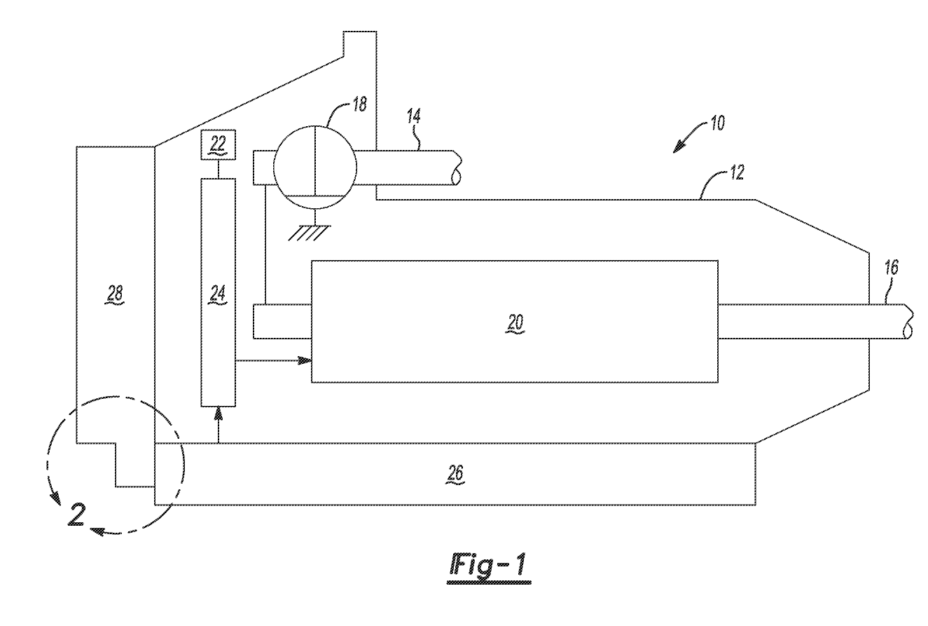

With reference to FIG. 1, a schematic diagram of an exemplary transmission is generally indicated by reference number 10. The transmission 10 is an automatic, front wheel drive, multiple speed transmission. However it should be appreciated that the transmission may be a manual transmission or any other type of transmission without departing from the scope of the present invention. The transmission 10 includes a typically cast, metal housing 12 which encloses and protects the various components of the transmission 10. The housing 12 includes a variety of apertures, passageways, shoulders and flanges which position and support these components. The transmission generally 10 includes an input shaft 14, an output shaft 16, a starting device 18, and a gear arrangement 20. The input shaft 14 is connected with a prime mover (not shown) such as an engine. The prime mover may be an internal combustion gas or Diesel engine or a hybrid power plant. The input shaft 14 receives input torque or power from the prime mover. The output shaft 16 is preferably connected with a final drive unit (not shown) which may include, for example, propshafts, differential assemblies, and drive axles. The input shaft 14 is coupled to and drives the gear arrangement 20 through the starting device 18. The starting device 18 is illustrated as a torque converter in the example provided, though various other hydrodynamic and mechanical devices may be used without departing from the scope of the present invention.

The gear arrangement 20 generally provides multiple forward and reverse speed or gear ratios between the input shaft 14 and the output shaft 16. The gear arrangement 20 may have various forms and configurations but generally includes a plurality of gear sets or a continuously variable unit having a chain or belt and movable pulley pairs, a plurality of shafts or interconnecting members, and at least one torque transmitting mechanism. The gear sets may include intermeshing gear pairs, planetary gear sets, or any other type of gear set. The plurality of shafts may include layshafts, countershafts, sleeve or center shafts, reverse or idle shafts, or combinations thereof. The torque transmitting mechanisms may include clutches, brakes, synchronizer assemblies or dog clutches, or combinations thereof, without departing from the scope of the present invention.

Operation of the starting device 18 and gear arrangement 20, including selection of gear ratios via clutch and brake engagement, is controlled by an electronic transmission control module (ETCM) 22 and a hydraulic control system 24. The ETCM 22 is preferably an electronic control device having a preprogrammed digital computer or processor, control logic, memory used to store data, and at least one I/O peripheral. The control logic includes a plurality of logic routines for monitoring, manipulating, and generating data. The ETCM 22 controls the actuation of the torque transmitting mechanisms in the gear arrangement 20 via the hydraulic control system 24. The hydraulic control system 24 generally includes electrically controlled solenoids and valves that selectively communicate hydraulic fluid throughout the transmission 10 in order to control, lubricate, and cool the various components of the transmission 10.

The hydraulic fluid used by the hydraulic control system 24 is primarily stored in a sump or reservoir 26. The sump 26 is preferably located at a bottom of the transmission 10. A pump (not shown) produces a suction that draws the hydraulic fluid from the sump 26 and into the hydraulic control system 24 where the hydraulic fluid is used to engage torque transmitting mechanisms and to cool and lubricate the transmission 10.

The transmission 10 further includes a front or side cover 28 attached to a side or front of the transmission 10. The side cover 28 protects components of the hydraulic control system 24 within the transmission 10 and functions as a secondary transmission oil storage reservoir, as will be described in greater detail below.

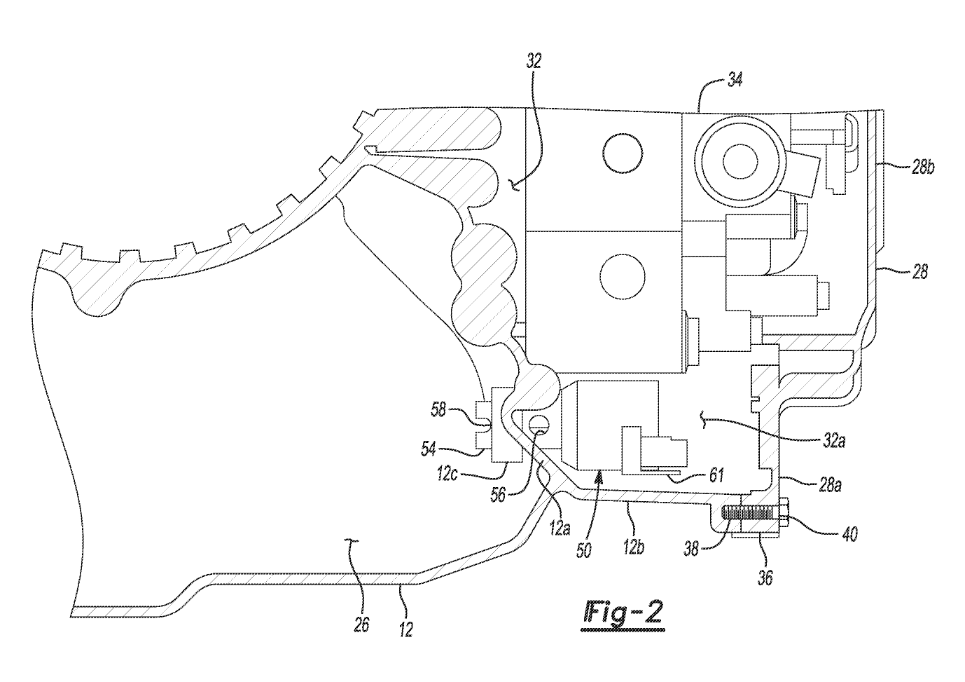

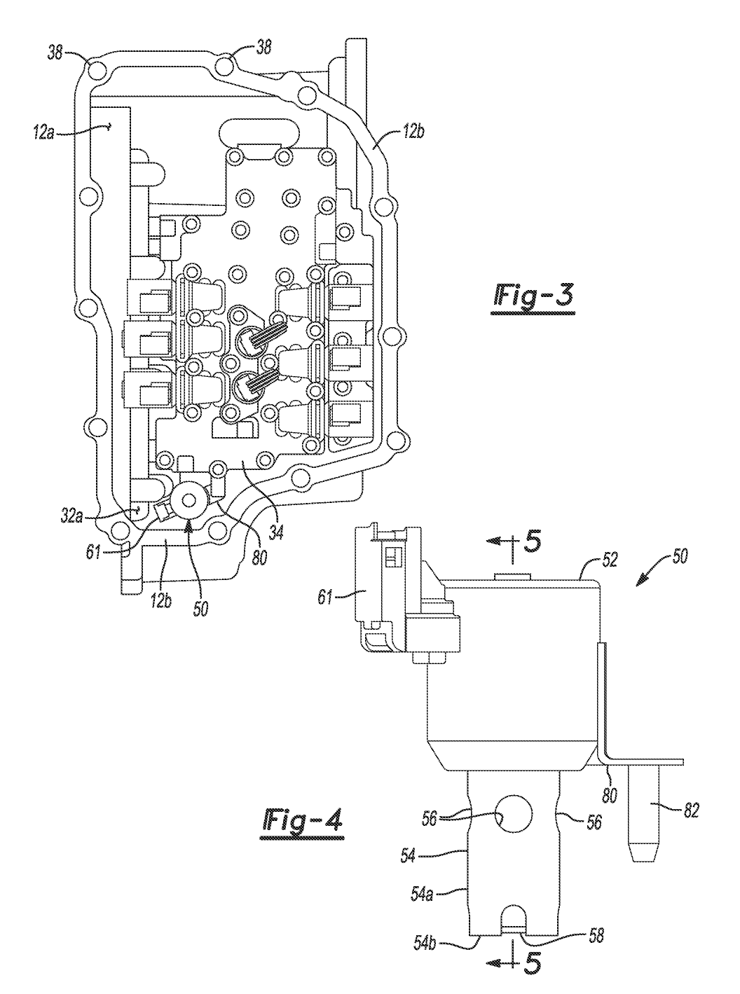

Turning to FIGS. 2 and 3, the transmission housing 12 includes a separator wall 12a that extends vertically from a bottom of the housing 12 to a top of the housing 12. A rim or flange 12b extends perpendicularly out from the separator wall 12a. The flange 12b is disposed around the entire outer periphery of the separator wall 12a, forming a pocket or cavity 32. Various components of the transmission 10 are disposed within the cavity 32, for example a transmission valve body 34 of the hydraulic control system 24. The transmission valve body 34 contains many of the pressure regulation valves, directional valves and solenoids that control the transmission 10.

The side cover 28 is configured to connect and seal to the flange 12b, thus enclosing the cavity 32. For example, the side cover 28 includes a wall or rim 28a that extends perpendicularly out from a main portion 28b. The rim 28a is disposed around the entire outer periphery of the side cover 28. The rim 28a includes a plurality of bolt holes 36 that align with a plurality of bolt holes 38 formed on the flange 12b. A plurality of bolts 40 or other fasteners connect the side cover 28 to the housing 12 overtop the cavity 32. A seal (not shown) is disposed on or radially inward of the rim 28a in order to seal the side cover 28 to the flange 12b of the housing 12.

A lower portion or secondary reservoir 32a of the cavity 32 acts as a secondary hydraulic fluid reservoir to the sump 26. The secondary reservoir 32a is not in communication with any rotating components of the transmission 10. Communication of the hydraulic fluid from the secondary reservoir 32a to the sump 26 is controlled via an active thermal control valve assembly 50. The control valve assembly 50 is disposed within the secondary reservoir 32a of the cavity 32 near a bottom of the transmission housing 12.

Turning to FIG. 4, the control valve assembly 50 is preferably an actively controlled wax pellet thermostat valve or an electro-mechanical armature. The control valve assembly 50 includes a coil housing 52 connected to a flange or sleeve 54. A plurality of inlet ports 56 are formed in a side surface 54a of the sleeve 54. An outlet port 58 is formed in a distal end 54b of the sleeve 54.

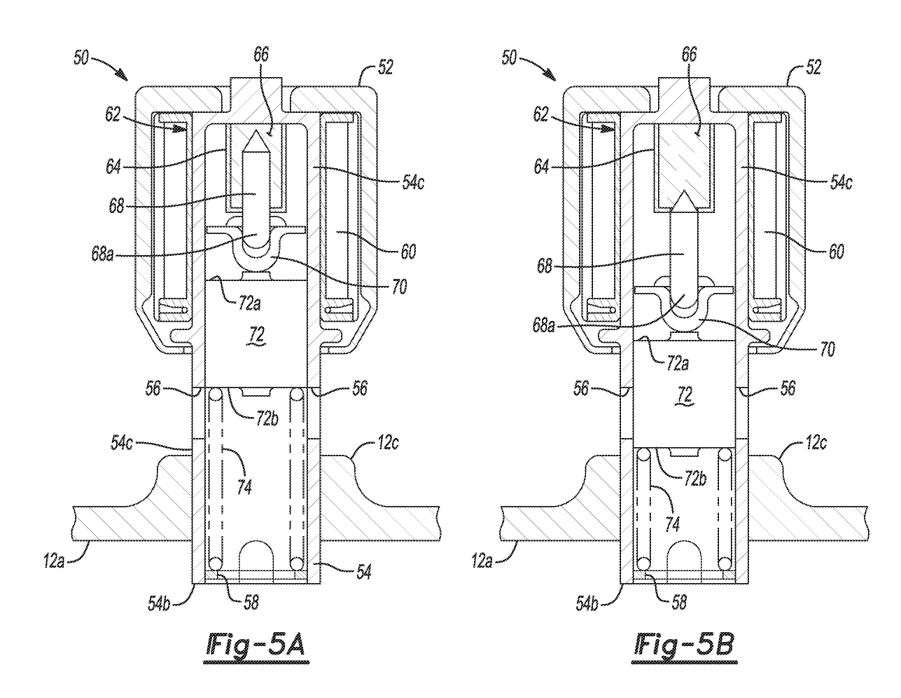

With reference to FIGS. 5A and 5B and continued reference to FIG. 4, a coil or other resistance element 60 is disposed about or wrapped around a closed end 54c of the sleeve 54. The coil 60 is connected to a connector port 61 disposed on an outside of the coil housing 52. The connector port 61 is interconnected to the ETCM 22 or to another power source. The coil 60 is enclosed and protected by the coil housing 52. A phase change or wax element 62 is disposed within the sleeve 54 proximate the closed end 54c and radially inwardly of the coil 60. The wax element 62 includes a pressure resistant vessel 64 filled with a special temperature tuned wax 66. The wax 66 is designed to melt at a specific temperature. A pin 68 is partially slidably disposed within the vessel 64 and extends out into the sleeve 54. A centering guide 70 is connected to a distal end 68a of the pin 68. An alternate design to the wax pellet is to utilize an electro-mechanical actuator which converts the electrical energy from the coil to mechanical movement in an armature.

A valve 72 is slidably disposed within the sleeve 54. The valve 72 is in contact with the centering guide 70 (or directly with the pin 68) on a first side 72a of the valve 72. A biasing member 74, such as a spring, is in contact with the valve 72 on an opposite side 72b. The valve 72 is moveable between a first position, shown in FIG. 5A, and a second position shown in FIG. 5B. The biasing member 74 biases the valve 72 to the first position. In the first position, the inlet ports 56 are in communication with the outlet port 58. In the second position, the valve 72 closes off the inlet ports 56 such that they do not communicate with the outlet port 58.

The valve 72 is moved to the second position against the bias of the spring 74 when the wax 66 melts due to a heat source. For example, when the temperature of the wax 66 crosses the phase change temperature from solid to liquid, the wax 66 expands. Expansion of the wax 66 within the vessel 64 pushes out the pin 68. The pin 68 contacts the valve 72 and moves the valve 72 to the second position, thus closing off the inlet ports 56 in the sleeve 54. The valve 72 returns to the first position when the temperature of the wax 66 falls below the melt temperature, the wax 66 contracts, and the spring 74 moves the valve 72 and pin 68 back to the first position.

The temperature of the wax 66 may be actively controlled by inducing an electrical current in the coil 60. The current in the coil 60 generates heat around the wax element 62, thereby selectively inducing a phase change in the wax 66. The normal operating conditions of the transmission 10 may also create thermal conditions that melt the wax 66.

Returning to FIG. 2, the control valve assembly 50 is connected to the separator wall 12a of the housing 12 by a bracket 80 and pin 82. The distal end 54a of the sleeve 54 extends through a support collar 12c formed in the separator wall 12a such that the inlet ports 56 are disposed in the secondary reservoir 32a and the outlet port 58 is disposed within the sump 26. Thus, communication between the sump 26 and the secondary reservoir 32a is controlled by activation of the control valve assembly 50. For example, the fluid level in the sump may be kept reduced by storing fluid within the secondary reservoir 32a by commanding a current in the coil 60, thus inducing a phase change in the wax 66 and moving the valve 72 to close the control valve assembly 50. Closing of the control valve assembly 50 hydraulically isolates the secondary reservoir 32a from the sump 26 thereby keeping the fluid level within the sump 26 to a predefined minimum. This predefined minimum is controlled by a distance of the control valve assembly 50 from a bottom of the sump 26. When the transmission cools and the current in the coil 60 is reduced, the wax 66 may again solidify, moving the control valve assembly 50 into the open position. Transmission fluid can then communicate from the secondary reservoir 32a through the inlet ports 56, out the outlet port 58 and into the sump 26.

Keeping the level of hydraulic fluid in the sump 26 to a minimum enables components of the gear arrangement 20 such as planetary gear sets, shafts or members, and clutches or brakes to rotate with a minimum of spin losses. The result is a more efficient transmission providing improved fuel economy.

The description of the invention is merely exemplary in nature and variations that do not depart from the general essence of the invention are intended to be within the scope of the invention. Such variations are not to be regarded as a departure from the spirit and scope of the invention.

The following is claimed:

1. An assembly for use in a transmission of a motor vehicle, the assembly comprising:
a first fluid reservoir;
a second fluid reservoir; and
a control valve assembly comprising:
a heat source;
a wax element configured to undergo a phase change in response to the heat source;
a valve moveable between a first position and a second position by the phase change of the wax element; and
a sleeve having a first port and a second port, wherein the first port is in direct fluid communication with the first fluid reservoir and the second port is in direct fluid communication with the second fluid reservoir, and
wherein the valve allows fluid communication between the first port and the second port when in the first position and prevents fluid communication between the first port and the second port when in the second position.

2. The assembly of claim 1 wherein the first fluid reservoir is located in a sump of the transmission and the second fluid reservoir is located in a side cover of the transmission.

3. The assembly of claim 1 wherein the wax element includes a pressure resistant vessel filled with a temperature tuned wax, wherein the wax undergoes the phase change at a specific temperature.

4. The assembly of claim 3 wherein the wax element further includes a pin partially slidably disposed within the pressure resistant vessel and extending out into the sleeve to contact the valve.

5. The assembly of claim 4 further comprising a biasing member disposed within the sleeve to bias the valve to the second position.

6. The assembly of claim 1 wherein the heat source is a coil disposed around the wax element to which a current is applied to generate heat.

7. The assembly of claim 1 wherein the wax element undergoes the phase change when an operating temperature of the transmission exceeds a threshold.

8. The assembly of claim 1 further comprising a separator wall disposed between the first fluid reservoir and the second fluid reservoir, and the control valve assembly is connected to the separator wall and the sleeve is extended through the separator wall.

9. The assembly of claim 8 wherein the separator wall includes a support collar that receives the sleeve of the control valve assembly.

10. The assembly of claim 1 wherein the first port is disposed in a distal end of the sleeve and the second port is disposed in a side surface of the sleeve.

11. The assembly of claim 10 wherein the valve covers the second port when the valve is in the second position.

12. A transmission comprising:
a transmission housing that defines a sump;
a side cover connected to the transmission housing that defines a reservoir; and
a control valve assembly comprising:
a heat source;
a phase change element configured to undergo a phase change in response to the heat source;
a valve moveable between a first position and a second position by the phase change of the phase change element; and
a sleeve having a first port and a second port, wherein the first port is in direct fluid communication with the sump and the second port is in direct fluid communication with the reservoir, and
wherein the valve allows fluid communication between the first port and the second port when in the first position and prevents fluid communication between the first port and the second port when in the second position.

13. The transmission of claim 12 wherein the sump is hydraulically isolated from the reservoir when the valve is in the second position.

14. The transmission of claim 12 wherein the phase change element includes a wax element that includes a pressure resistant vessel filled with a temperature tuned wax, wherein the wax undergoes the phase change at a specific temperature.

15. The transmission of claim 14 wherein the wax element further includes a pin partially slidably disposed within the pressure resistant vessel and extending out into the sleeve to contact the valve.

16. The transmission of claim 15 further comprising a biasing member disposed within the sleeve to bias the valve to the second position.

17. The transmission of claim 12 wherein the heat source is a coil disposed around the phase change element to which a current is applied to generate heat.

18. The transmission of claim 12 wherein the wax element undergoes the phase change when an operating temperature of the transmission exceeds a threshold.

19. The transmission of claim 12 further comprising a separator wall disposed between the sump and the reservoir, and the control valve assembly is connected to the separator wall and the sleeve is extended through the separator wall.

20. The transmission of claim 12 wherein the first port is disposed in a distal end of the sleeve and the second port is disposed in a side surface of the sleeve.
